(19) United States
(12) Patent Application Publication
(10) Pub. No.: US 2012/0238920 A1
(43) Pub. Date: Sep. 20, 2012

(54) REHABILITATIVE APPARATUS FOR TREATING REFLEX SYMPATHETIC DYSTROPHY

(75) Inventors: Moacir Schnapp, Memphis, TN (US); Kit S. Mays, Memphis, TN (US); Margaret J. Hwang, Burtonville, MD (US); Matthew A. Trimble, Boston, MA (US)

(73) Assignee: NOVOKINETICS, LLC, Memphis, TN (US)

(21) Appl. No.: 13/234,325

(22) Filed: Sep. 16, 2011

Related U.S. Application Data
(60) Provisional application No. 61/403,458, filed on Sep. 16, 2010.

(51) Int. Cl. A61H 1/02

(52) U.S. Cl. 601/5

(57) ABSTRACT

The apparatus provides active and passive exercise to the hand and wrist of a patient afflicted with the symptoms of reflex sympathetic dystrophy. The apparatus employs a hand or wrist glove to be worn by the patient's affected hand, the back of which is attached through an arm to a central post and the distal portion encasing the fingers, is attached to a vertical handle, which is rotated about the post, serving as the axis of rotation. A torque sensor is coupled to the motor shaft to measure the degree of patient input from a programmed speed and force rate by sensing the active input of the patient and reducing the motor input to the cycle allowing the patient to “drive” the exercise.

### CROSS-REFERENCE TO RELATED APPLICATION

This application claims the benefit of U.S. Provisional Patent Application Ser. No. 61/403,458, filed Sep. 16, 2010, entitled “Rehabilitative apparatus for treating reflex sympathetic dystrophy” which is hereby incorporated by reference in its entirety,

### STATEMENT REGARDING FEDERALLY SPONSORED RESEARCH OR DEVELOPMENT

Not Applicable

### BACKGROUND OF THE INVENTION

1. Field of the Invention

The present invention relates to physical therapy devices and more particularly to a rehabilitative apparatus for treatment of reflex sympathetic dystrophy and related disorders that cause weakness of muscles, joint stiffness, loss of mobility, pain and in severe cases, an atrophy of the associated tissue. Reflex Sympathetic Dystrophy (RSD), or type 1 Complex Regional Pain Syndrome (CRPS), is a chronic disease that can be characterized by some or all of the following symptoms:

spontaneous pain

hyperalgesia (increased sensitivity to pain)

allodynia (increased pain response to a non-painful stimulus)

swelling

joint stiffness

edema of skin and subcutaneous tissues

abnormal vasomotor activity (related to the nerves and muscles controlling the blood vessels)

abnormal sudomotor activity (related to the neurons controlling the sweat glands)

impairment of motor function

trophic changes (e.g. hair, skin, or nail texture may change; decreased range of motion)

depression

The disease typically arises in a localized area after a traumatic incident or injury. From there, the disease can spread to other regions of the body. Typically, the upper extremities are more likely to be affected than the lower extremities. In these extremities, the distal elements (i.e. fingers and toes) are often the most vulnerable. At this time, there is no definitive evidence for a genetic basis for RSD; however, pilot studies suggest that there is likely some effect.

### Etiology

Currently, the exact cause of CRPS is not well-understood. In type 1 CRPS (RSD), there is no obvious nerve injury detectable. Often times, RSD might occur after a seemingly benign accident or trauma. In type 2 CRPS (also known as causalgia), an observable nerve injury exists. For some time, it was thought that the disease was caused by some malfunction of the sympathetic nervous system (hence the name reflex sympathetic dystrophy). However, the disease is much more complicated than the name suggests—it has been shown that sympathetic changes do not necessarily contribute to pain or may not be involved throughout the entire course of the disease for every patient, and that dystrophy only occurs in perhaps 15% of cases. It is likely that the actual pathophysiology of CRPS is a combination of various factors, including trauma-related cytokine release (cytokines are signaling proteins used by cells to communicate with each other), exaggerated neurogenic inflammation (inflammation caused by neurons releasing inflaming agents), sympathetically maintained pain (referred to above), and cortical reorganization in response to chronic pain (one of the possible symptoms of CRPS is the loss of touch in certain areas, which is partially mediated by cortex).

Reflex Sympathetic Dystrophy (RSD), or type 1 Complex Regional Pain Syndrome (CRPS), is a painful condition usually arising from trauma involving nerves in a limb. In a typical example, a simple fracture of the wrist may hurt beyond what would normally be expected despite proper casting of the limb. In a few days the pain intensifies and assumes a constant burning quality, usually involving the whole limb. The skin may become sensitive to the point that light touch or even air from such as a fan causes excruciating pain. Dystrophic changes ensue, initially with swelling, changes in color, temperature and appearance of the skin, followed by progressive atrophy of muscles, shortening of ligaments, ankylosing (or freezing) of the joints and later regional osteoporosis (or thinning) of the bone. The end result may be an inability to fully open or close the hand, limited rotation of the wrist for pronation/supination and flexion/extension. The ankle, elbow, knee and especially the shoulder joint may be similarly affected if related tissues are injured.

2. General Background of the Invention

Preferred embodiments of the present invention relate to improved apparatus for the treatment and rehabilitation of the effects of reflex sympathetic dystrophy involving the fingers, hands and the joints of the wrists. In the present invention, an arm handle for articulating the hand or wrist is controlled by a centralized motor and gearhead, enabling automated clockwise and counterclockwise rotation of the articulating handle. Anchored to the device's central axis and also connected to the articulating handle is a fabric glove which guides the hand or wrist in a pre-determined range of motion around a central pivot point. In order to promote and monitor active participation from the patient, the inventive RSD device tracks the patient's efforts in articulation and adjusts the handle's speed and movement accordingly to how “dominant” the patient is able to be in active participation in the flexing and extending of the hand or wrist. To achieve the desired patient participation input a load cell (torque sensor) is incorporated into the motor drive to provide continuous force sensing and input into the monitoring center. When the patient's hand becomes “active”, i.e., asserts physical force into the articulation, the motor adjusts its speed at an appropriate variable rate. This adjustment of speed is in proportion to the input effort from the patient, thereby decreasing the device assistance provided in the articulation cycle. Should the patient relax the positive input, toward a “passive” state, the torque sensor provides information to the monitoring center and the input of the motor driven articulation reverts to the preset default speed, as set up according to a predetermined exercise regimen. The healthcare professional prescribes the parameters of the physical activity and these values are entered into the program for controlling the motor in the articulation regimen.

The RSD Rehabilitation Apparatus is controlled through a task directing computer program which allows the user (a briefed patient, physician or other healthcare professional) to prescribe the parameters of the regimen, including desired range of motion, initial starting position, speed of motion, and sensitivity of the load cell (torque sensor) to the patient's effort level. The software application (running preferably on a laptop type computer), communicates directly with the device, also allows the user to collect regimen history, save new settings and load previous settings in order to track patient participation/improvement over successive rehabilitation sessions.

In this version of the device, the handle is in CPM (continuous passive motion) mode at all times, meaning the device is always moving the handle and there is no instance when the patient is independently moving the handle on his/her own or through his/her own force. However, in order for the patient to be able to move his/her hand “freely” during exercises, the handle constantly tries to stay ahead of and “out of the way” of the patient's hand by monitoring how much effort the patient is using (inputting). This effort is measured through the device by taking in as input the amount of torque the patient is putting on the handle. When there is significant torque on the handle in the direction in which the handle is moving, the device, on sensing the patient input, will increase the speed of the handle so that the handle moves ahead of the patient's hand. This allows the patient to not be inhibited by the glove or handle and continue moving at the patient's pace. The load cell is the component that acts as the torque sensor and is attached in the coupling of the motor drive to the handle.

The current treatments universally include medications, nerve blocks and other similar modalities, but physical therapy is always necessary. Current physical therapy employs passive exercises such as having a therapist mobilize the affected limb. However, this therapy is limited by the patient's pain and fear of being hurt due to excessive manipulation by the therapist. Machines for continuous passive motion (CPM) have been developed for stiff or surgically repaired joints but do not take into account the patient's intense pain and tissue sensitivity. We have determined that active exercises, by involving the brain, spinal cord, nerves and nerve-muscle junction are a more complete approach, and are necessary for the reeducation of the limb and reversal of the dystrophic changes, not achieved through purely passive exercises.

In treating patients with RSD, we have found many have many developed “overuse syndromes” of the limb, mainly involving tendinitis from excessive exercises. It has become clear that the available exercise machines do not take into account the fact that these patients have to work not only against the machine's resistance, but also the internal resistance caused by the shortened muscles and ligaments as well as the stiffened and frozen joints.

We have developed a machine to address the specific needs of patients with RSD, although other medical conditions may benefit through use of the inventive apparatus. It is likely that treatment of the dystrophy from strokes, collagen diseases such as rheumatoid arthritis and similar injuries and abnormalities may be similarly effective as in RSD. The same principles used to treat the wrist as in the machine herein described, may be utilized to treat other areas of the body affected by RSD, such as the fingers, elbow, shoulder, ankle and the knee.

The use of the normal limb during the exercise may allow the central nervous system to use simultaneous bilateral use as a template to correct the lack of coordination of the malfunctioning limb/joint. The torque sensor in the handle also allows the patient more opportunity to influence the regime and control the articulation, effectively increasing the safety and making the apparatus more user friendly.

Pain is a significant deterrent to a patient's ability to exercise. Proper positioning of the limb/joint is a must. The inclusion of the individual different types of fabric gloves, one targeting the wrist, and the other targeting the hand, in the preferred embodiment allows for a more comfortable, physiologic grasp, respecting the anatomy of a partially closed hand. The gloves, preferably made of a supportive material such as 0.5 mm thick neoprene, provide enough structure to guide the hand or wrist through the exercises while maintaining the correct positioning. Additionally, given the flexibility and adaptive nature of fabric, the gloves aren't rigid, but comfortable against the skin as the hand or wrist swings through the exercises. In the preferred embodiment, the gloves are attached to a cylindrical post, which also serves as the motor housing operating the articulating prime mover. The gloves enable attaching the hand/wrist in a back to post orientation, allowing the articulation to be through the hand/finger encasing glove, not otherwise constrained by rigid physical structure of the apparatus in order to permit the physiologic radial/ulnar deviation that occurs during pronation/supination. To specifically target the fingers for exercise, the hand glove fixes the hand in place behind the knuckles so that only the fingers and joints from the knuckles up move with the swinging handle which is rotated by the motor, articulating the hand by being attached to the glove beyond the extent of the fingers. The handle articulates in a circular arc, perpendicular to the parallel axes of the handle and post. Each of the fingers have a separate finger slot in the glove to keep the fingers snugly held while leading them into the full extension and full flexion positions. Ventilation holes along the inside of the finger slots and the palm area help cool the hand. A fastening strap, such as hook-and-loop material, keeps the glove in place and prevents the glove from sliding off of the hand.

In the case of wrist exercise, the wrist glove fixes the hand in place on the post behind the wrist so that the wrist joint acts as the rotational axis of the exercise. To encourage the hand to act as a single unit (thereby concentrating the articulation in the wrist joint), the fingers are secured in a first position through the mechanics of a single pocket that is strapped down to the palm of the glove. Ventilation holes along the inside of the glove help to cool the hand. The hook-and-loop strap around the wrist keeps the glove in place and prevents the glove from sliding off of the hand. To enable a rapid “emergency” release, a highlighted (yellow) pull tab is attached to the wrist strap for immediate release from the glove and apparatus.

Various patents have been issued for apparatus directed to physical therapy of the fingers and wrist. Other than U.S. Pat. No. 6,149,612, issued to two of the inventors hereof, none that we are aware of are directed to the special problems presented in the rehabilitation of a patient suffering from RSD. There are a variety of exercise machines, some including rehabilitation for occupational objectives.

Early examples include the Hopkins U.S. Pat. No. 4,070,071 and the Bell U.S. Pat. No. 1,899,255. An apparatus directed specifically to mobilizing stiff joints is disclosed is U.S. Pat. No. 2,387,966 issued to Zander.

The Newman U.S. Pat. No. 4,077,626 provides an exercising apparatus that includes a platform, a bench mounted on the platform and adapted to provide a foot space on each side of the bench a bar traversing the bench attached at its ends to a pair of lines, a linear-to-rotational motion converter operably attached to said lines and adapted to convert the linear extension of said lines to rotational motion and to rewind said lines when said extension is relaxed, and a flywheel responsive to said linear-to-rotational motion converter and adapted so the pulling of said lines results in the rotation of said flywheel.

U.S. Pat. No. 4,337,050 issued to Engalitcheff provides a method and apparatus for rehabilitation of damaged limbs for use in operation of a tool, wherein accessories with handles corresponding to the handles of familiar tools are attached to a shaft in a manner such that the movements of the handle correspond to the normal operation of the tool product rotation of a shaft. A preselected resistance is applied to the rotation of the shaft by electrical, pneumatic, hydraulic, or mechanical means, and the resistance and the accessory attached can be varied in accordance with the capability of the damaged limb.

U.S. Pat. No. 4,647,036 issued to Huszczuk discloses a device for enabling the testing of a person's physical condition, by enabling measurement of the energy expended by the person to be tested thereby, in manually maintaining rotation of a flywheel in a stationary bicycle, against resistance applied to the flywheel, for use in determining the efficiency of the person's body in using energy, as an indication of such person's physical condition.

U.S. Pat. No. 4,809,970 issued to Beistegui provides and inertia mechanism for gymnastic bicycles having a pedaling axle. The mechanism includes an inertia flywheel and a set of cogged crowns of different diameters and different number of cogs mounted on the flywheel and operatively connected to each other and to the pedaling axle so that weight and the size reduction of the flywheel are counterbalanced by the set of the cogged crowns actuated upon the actuation of the pedaling axle.

U.S. Pat. No. Re. 33,182 issued to Jean-Claude Pecheux is directed to apparatus for re-educating finger joints wherein the hand is rested on a support at the individual joint and an articulated segment of the finger is engaged by the apparatus.

U.S. Pat. No. 5,115,806 issued to William Greuloch, et al, is directed to a passive motion device to impart a reciprocating spiral motion to one or more of the fingers. Reciprocating motion is effected via telescoping bars attached to the finger tips, which in turn is rotated in an arc.

U.S. Pat. No. 5,458,860 issued to Robert T. Kaiser, et al is directed to a continuous passive motion device for the wrist. The device is strapped to the forearm and the wrist is affixed in a yoke for articulation through a pivoted coupling to the device proper.

U.S. Pat. No. 5,738,636 issued to Saringer, et al, is directed to a passive motion device for joints. The device is a fully passive device for articulating a joint according to a fixed regimen, with no interaction with the patient.

U.S. Pat. No. 6,506,172 issued to George R. Hepburn, et al is directed to a Supinator/Pronator Therapy System To Bring Mobility To Wrist, Forearm and/or Elbow. It is a strictly passive motion device for delivering set regimens of articulation for finite periods during a treatment period.

Prior active exercise machines can induce overuse damage. There are several assisted passive devices used for rehabilitation such as a continuous positive motion or “CPM” devices, but they do not allow for the patient's control. They do not stimulate muscle use or proprioception.

### BRIEF SUMMARY OF THE INVENTION

A principal objective of the present invention is to aid in the rehabilitation of neuro-musculo-skeletal disorders involving the limbs. The present invention combines active and passive exercises, allowing the patient full control over the resistance and speed of exercise. In a preferred embodiment, the bilateral simultaneous use of opposite limbs, (e.g., both hands) as they are synchronously involved in the exercise regimen, enables the therapy to take advantage of the reeducation of the afflicted limb that occurs at the spinal and supraspinal centers induced by the healthy limb, thereby greatly benefitting impaired proprioception.

The present invention provides an apparatus specifically directed to the range of motion of the afflicted limb, which in the instance of the hand and wrist enables both flexion-extension and pronation-supination. Through the controls on the user interface software, the therapist or patient is able to set the device's range of motion, number of cycles or times the motor runs through the range of motion, the motor's speed (which directly controls the handle's speed), and the sensitivity, which defines how quickly the handle responds to the user's efforts. Technically speaking, the user interface software allows the user to control and configure the behavior of the motor controller to process inputs from the position sensor and the load cell. The motor controller always operates in a mode where it takes input from the position sensor at approximately 4000 times per second, and applies a command signal to the motor such that it will maintain a desired position. The apparatus provides active and passive exercise to the hand and wrist of a patient afflicted with the symptoms of reflex sympathetic dystrophy. The apparatus employs a hand or wrist glove to be worn by the patient's affected hand, the back of which is attached through an arm to a central post and the distal portion encasing the fingers, is attached to a vertical handle, which is rotated about the post, serving as the axis of rotation. The apparatus addresses specifically the range of motion of the wrist, both for flexion-extension and pronation-supination. The handle and arm are attached via the arm to the vertical shaft of the motor, which is controlled by a computer program to assist or resist the input action of the patient rotating the hand and fingers through an exercise cycle according to input instructions of the healthcare professional. A torque sensor is coupled to the motor shaft to measure the degree of patient input from a programmed speed and force rate by sensing the active input of the patient and assessed by the controlling program and reducing (or otherwise adjusting) the motor input to the cycle allowing the patient to “drive” the exercise, again according to the parameters input by the healthcare professional or patient (as previously advised by the healthcare professional). Conversely, should the patient relax the input, the torque sensor detects the lack of patient participation and the program signals the motor to run at the necessary speed to maintain the parameters of the cycle, wherein the machine tends toward becoming a passive motion exerciser. By being able to sense the patient input and accommodate the total energy developed during treatment, the motor continues the rotation of the patient's wrist, and effects a decrease in the tendon overload which normally occurs in normal physical therapy. The inclusion of a “wrist glove provides an alternative embodiment for flexion and extension of the wrist with the orientation of the handle effectively at right angles to the center shaft, whereby the wrist is flexed and extended. Operation of the wrist exercise regime is similar to that of the hand, monitoring patient input and adjusting the motor input to the regimen as previously input to the apparatus prior to the exercise cycle.

### BRIEF DESCRIPTION OF THE DRAWINGS

FIG. 1 is pictorial view of the present invention.

FIG. 2 is a pictorial view of the invention of FIG. 1 including the hand glove.

FIG. 3 is a pictorial view of the invention of FIG. 1 showing internal detail of the invention.

FIG. 4 is a side pictorial view of the invention of FIG. 1

FIG. 5 is a side view of the invention of FIG. 4, from the opposite end.

FIG. 6 is a plan view of the invention showing the handle in three locations.

FIGS. 7, 8 and 9 are pictorial views of the invention of FIG. 1 showing the hand glove in different positions (specifically in full extension, neutral and full flexion).

FIGS. 10, 11 and 12 are pictorial views of the invention of FIG. 1 showing the wrist glove in different positions (specifically in full extension, neutral, and full flexion positions).

FIG. 13 is a graph of the wave trajectory of the handle powering the wrist and hand glove.

For a further understanding of the nature, objectives, and advantages of the present invention, reference should be made to the following detailed description, read in conjunction with the following drawings, wherein like reference numerals denote like elements and wherein:

### DETAILED DESCRIPTION OF THE INVENTION

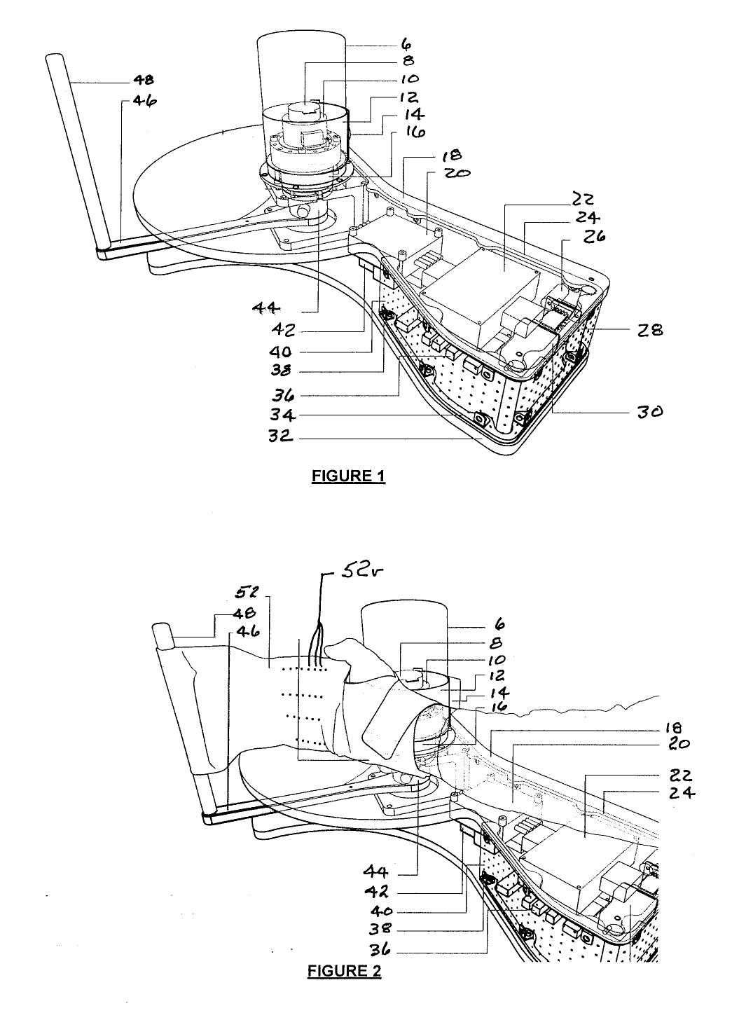

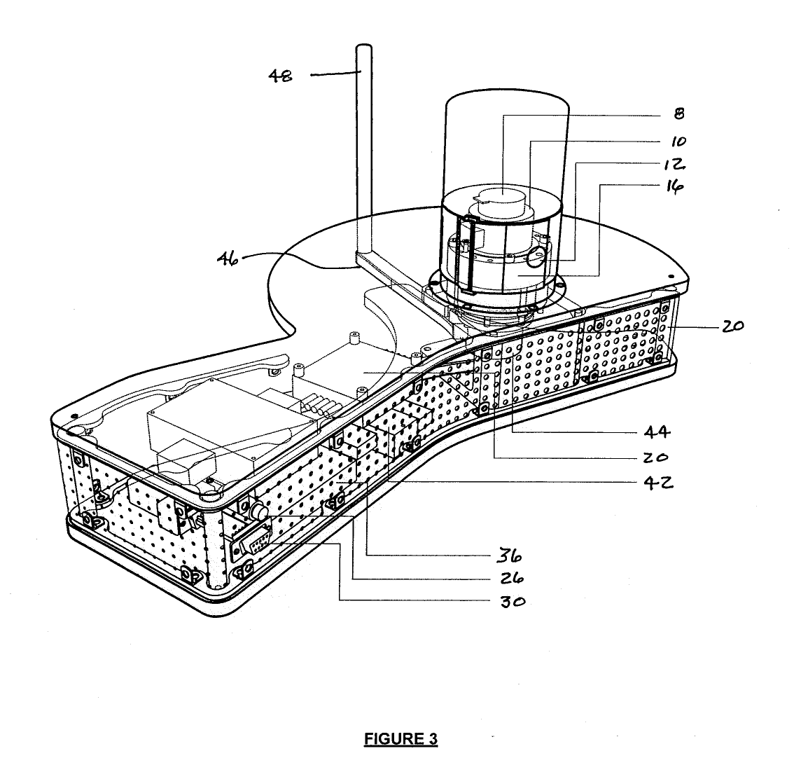

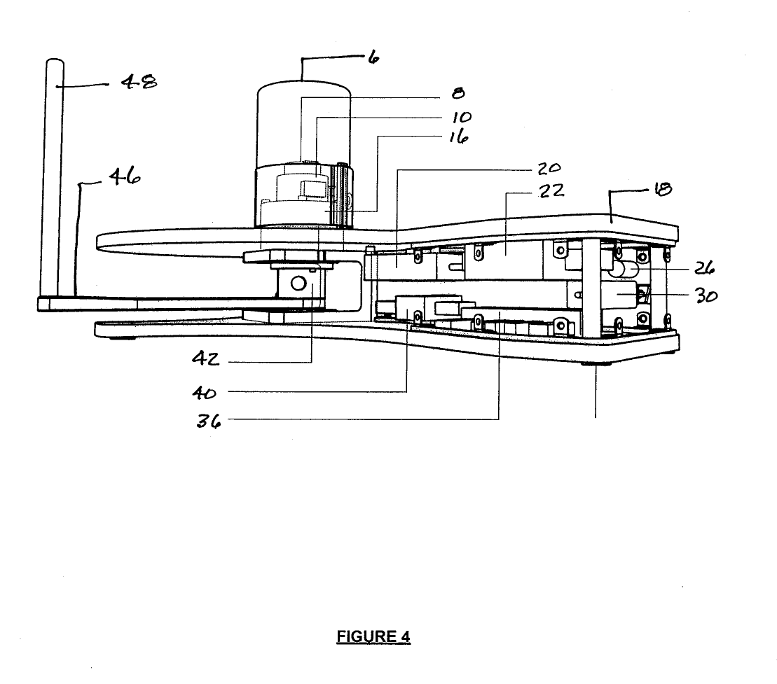

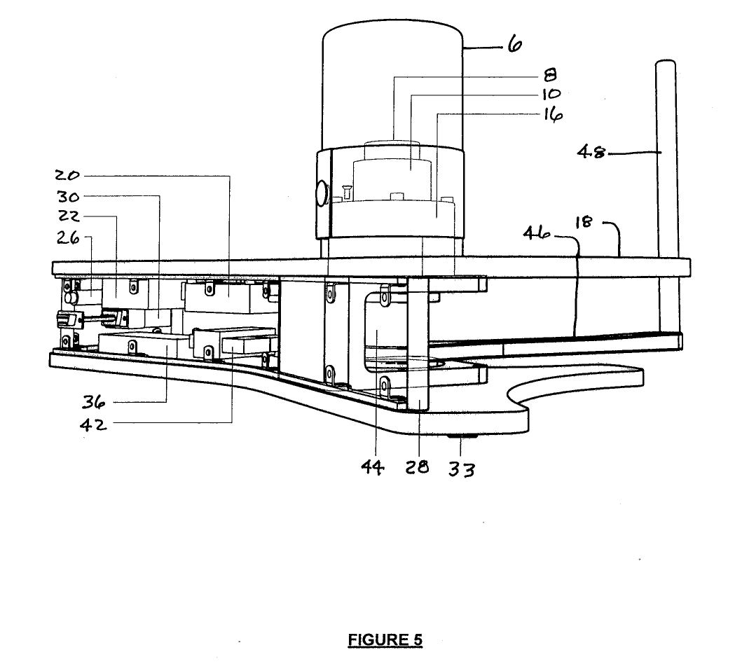

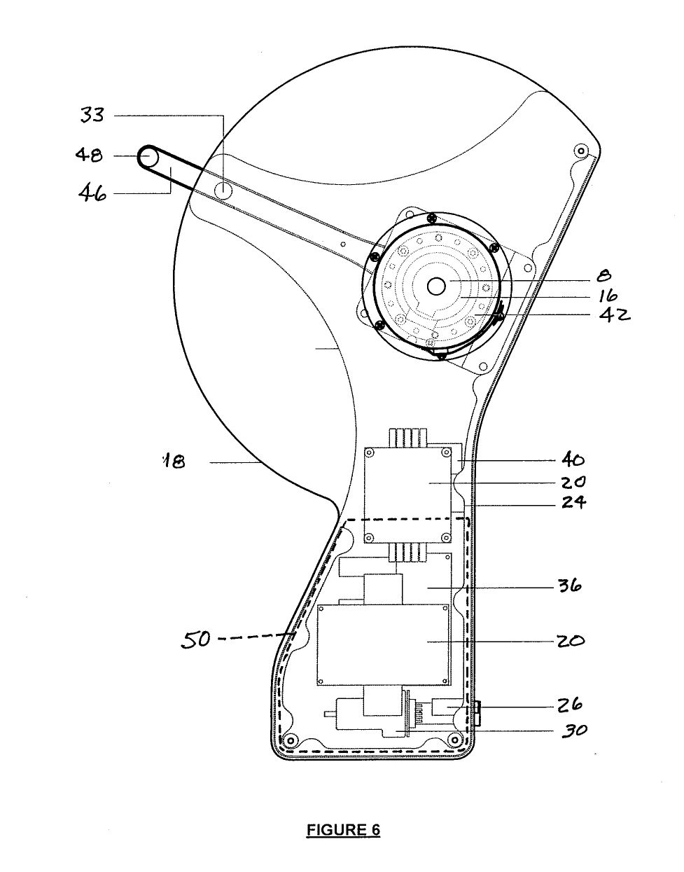

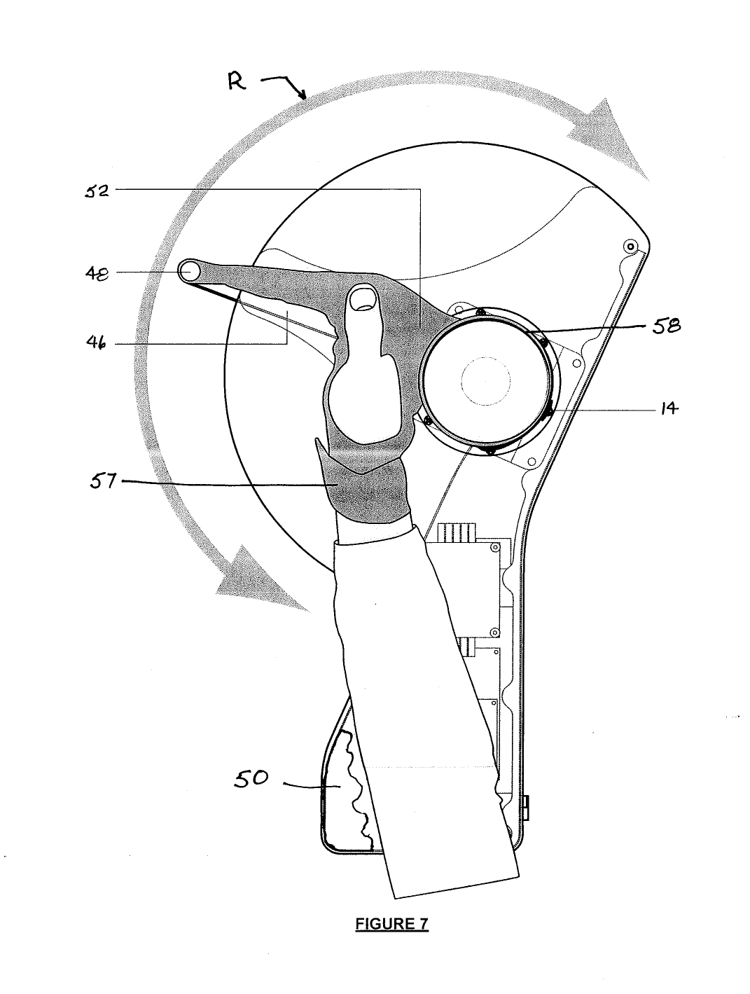

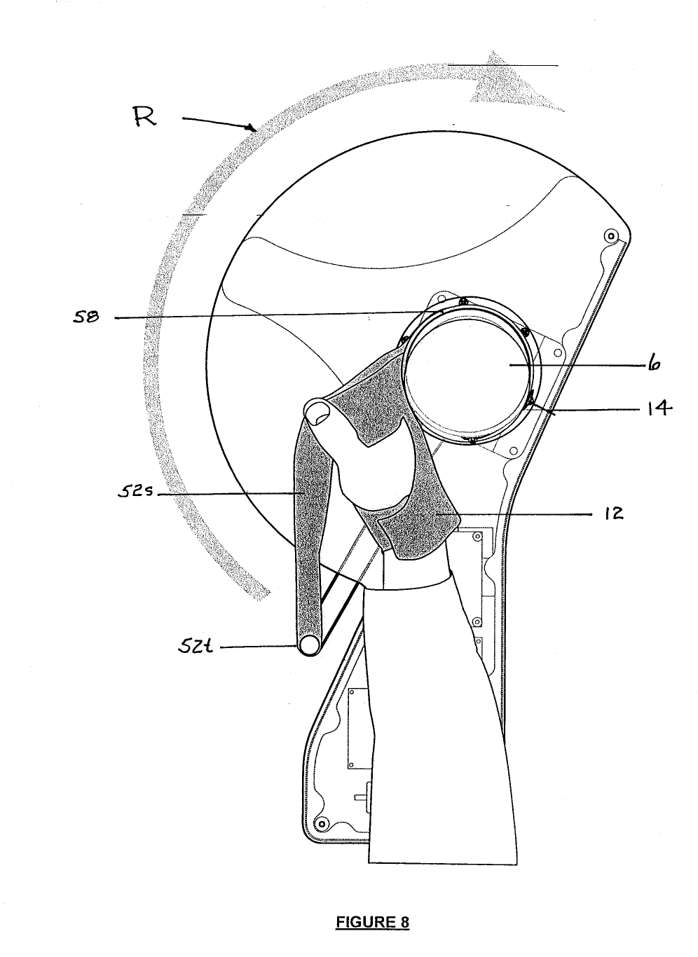

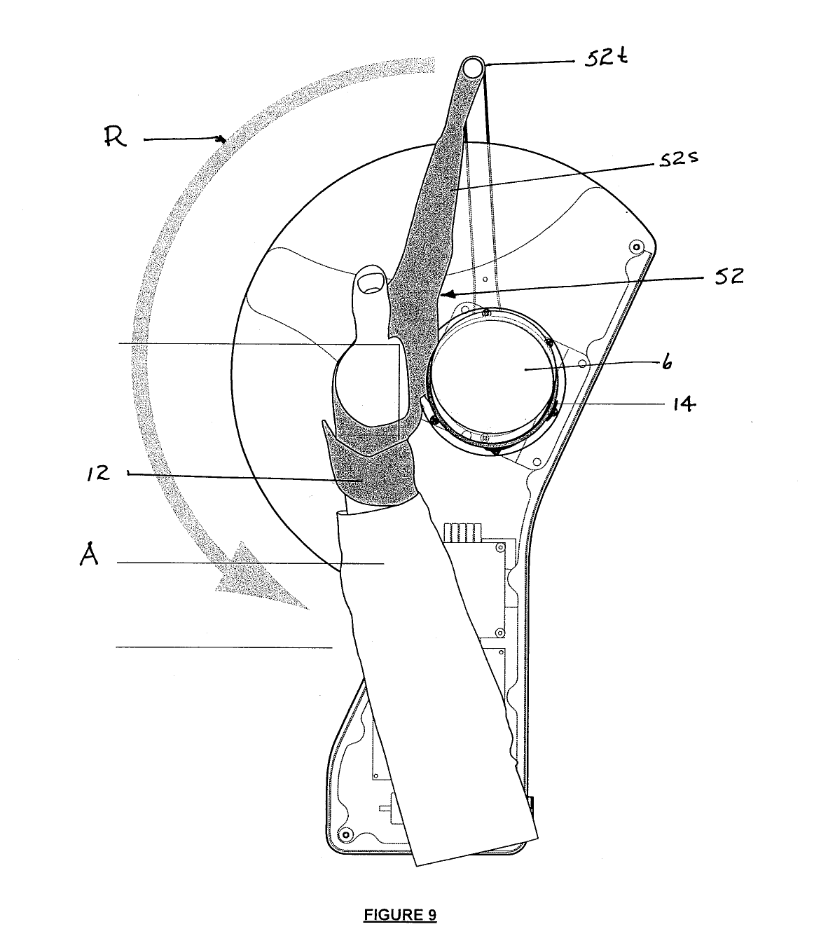

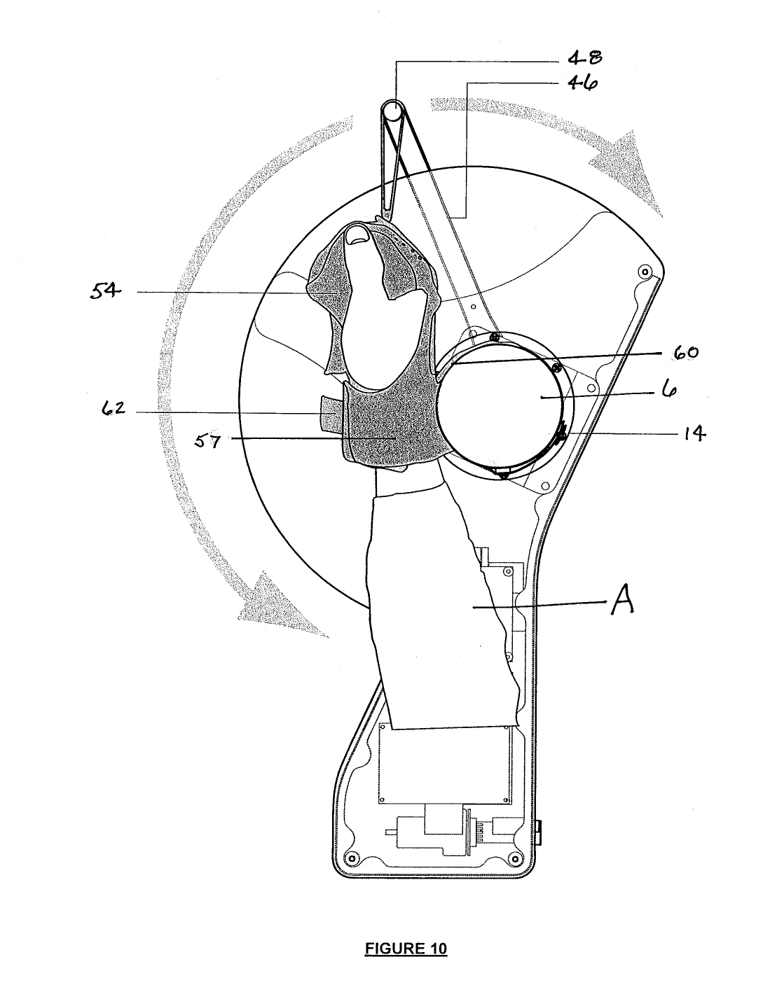

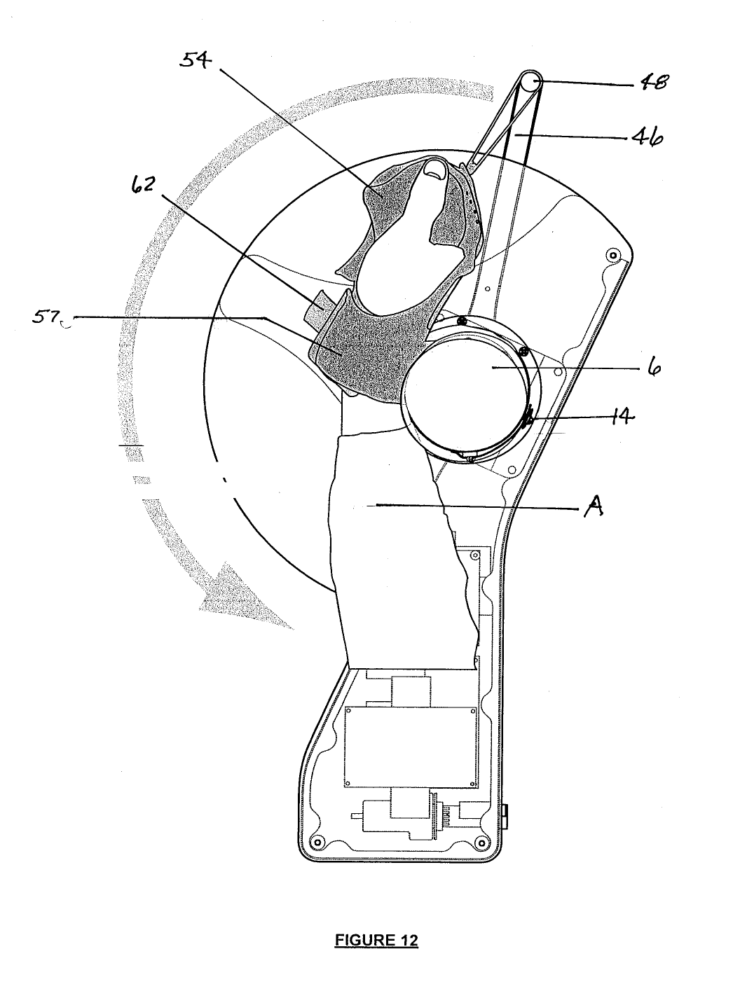

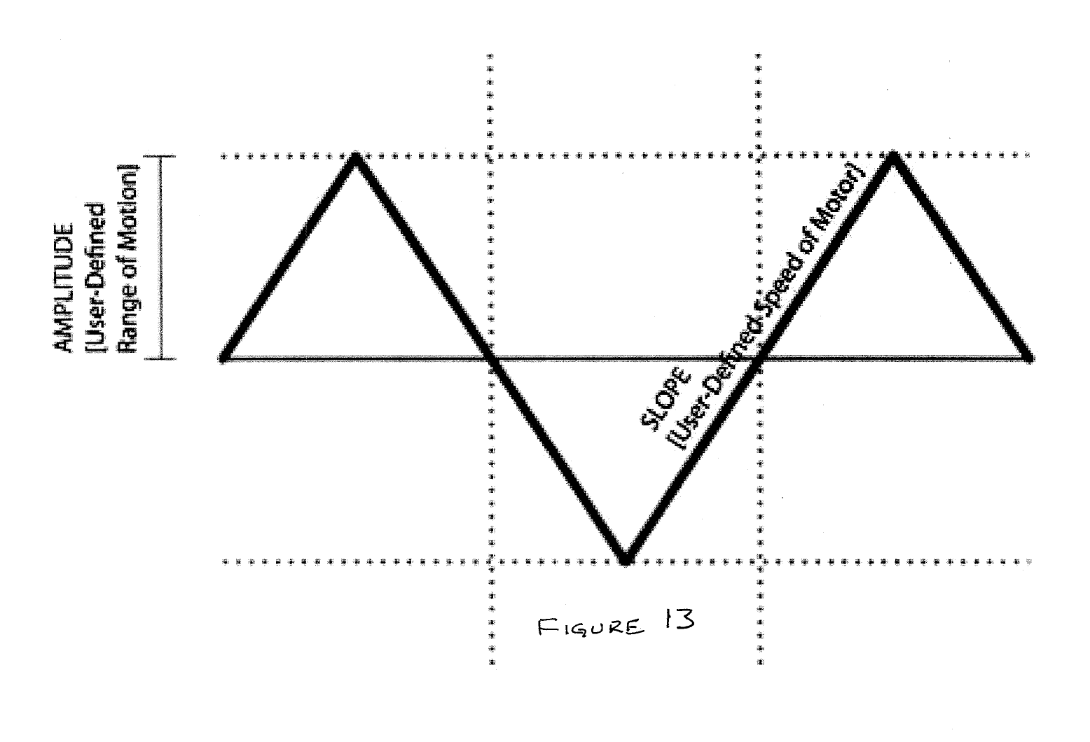

FIG. 1 shows the preferred embodiment of the apparatus of the present invention adapted for pronation-supination therapy and for flexion-extension therapy, designated generally by the numeral 2. The embodiment of rehabilitative apparatus 2 for treatment of reflex sympathetic dystrophy (RDS) shown in FIG. 1 through 12. The apparatus 2 includes a motor housing 6 forming a cylindrical post and mounted in structural channel 4, against which the articulating hand or wrist glove (later described) is affixed. The post 6 covers motor 10 (such as a Maxon EC 45 Flat (50-watt) with encoder) and Gear Head 16 (such as Harmonic DriveCSG14) which articulates handle 48 via arm 46 which is attached to the shaft of the motor 10. Mounted on top of the motor 10 is encoder/position sensor 8 (such as a Maxon MR Encoder, PN 228182) which senses the position and/or speed of the HD/gearhead 16 unit. The signal is sent to the motor control board 36 to be processed as part of the control algorithm. During operation, motor 10 provides reciprocal movement to the arm 46 and handle 48 to which glove 52 (FIG. 2) is attached. As previously noted, through the controls on the user interface software, the therapist or patient is able to set the device's range of motion, number of cycles or times the motor runs through the range of motion, the motor's speed (which directly controls the handle's speed), and the sensitivity, which defines how quickly the handle responds to the user's efforts. Technically speaking, the user interface software allows the user to control and configure the behavior of the motor controller to process inputs from the position sensor and the load cell. The motor controller always operates in a mode where it takes input from the position sensor at approximately 4000 times per second, and applies a command signal to the motor such that it will maintain a desired position. Positions are received as commands from the user interface software. Motor 10 is connected through interconnect board 40 including strain gage and motor control board 36 (Xitome Design) which are ultimately powered by power supply 22 (such as an Emerson network power supply, ss140c-7612) connectable to standard 110 volt service via connector 26. As later explained, during operation of the device 2, patient input to the articulation is sensed by a torque sensor 42 (such as load cell Transducer Techniques TRT-50) and the signal supplied to strain gage amp 20 (i.e., Transducer Techniques TMO-1). A D Sub Terminatior 30 both terminates the can bus with a loading resistor and changes the interface from mini-usb to dsub (CAN standard).

FIG. 6 illustrates the RSD machine 2 with the arm 46 in three positions: 46o, or open; 46m, or mid-range; and 46c closed; or the full extension, neutral and full flexion conditions. Illustrated (also in FIG. 3) is pad 50 to provide a comfortable surface to rest the Arm while treatments are being performed.

As illustrated in FIGS. 7, 8 and 9, hand exercise glove 52, into which the hand has been inserted, is attached to post 6 via a connecting strap 58 attached to the back of the glove, positioned on the opposite side of post 6 as glove 52. The fastening strap 58 is located such that the back of the hand is positioned such that the knuckles are adjacent the center of the post 6. Glove finger sleeve 52s is adjoined at its extremity to handle 48 so as to be articulatable throughout the range R illustrated on FIGS. 7 through 9. Each hand glove has individual slots 52s for each of the fingers. Further, the glove, including the fingers are ventilated for patient comfort. The glove material is flexible so as to cushion any movement of the machine, and is preferably made of a neoprene material. In respect of the material, whether solid (neoprene) or woven, the material should exhibit a resiliency or elasticity of about 30% to 50%. During articulation of the fingers, they may move freely through their normal range, as there is no rigid structure of the device to impede motion, or to present a pressure point generating discomfort. FIGS. 8 and 9 illustrate a hand within the glove 52, in neutral position and in full flexion position. Also illustrated are the fingers in the finger slots 52t the attachment to the post 6 and the strap 58 holding the glove 52 at the point of attachment to the post 6 (behind the knuckles) and glove strap 12 securing the glove 52 to the hand.

Further to the invention, pain and stiffness are a significant deterrent to a patient's ability to exercise. Proper positioning of the limb/joint by an adaptive support system is a must. The inclusion of the individual different types of fabric gloves 52, 54, made preferably of about 0.5 mm thick neoprene (about 0.3 mm to 0.7 mm are functional), with one adapted for the wrist 54, and the other adapted for the hand 52. As illustrated in the preferred embodiment, each allows for a more comfortable, physiologic grasp, respecting the anatomy of a partially closed hand. In the preferred embodiment, the gloves 52, 54 are attached to cylindrical post 6, which also serves as the motor housing operating the articulating prime mover. The gloves 52, 54 enable attaching the hand/wrist in a back to post 6 orientation, allowing the articulation to be through the hand/finger encasing glove, not otherwise constrained by rigid physical structure of the apparatus (post 6) in order to permit the physiologic radial/ulnar deviation that occurs during pronation/supination.

A major challenge in building an apparatus for the rehabilitation of RSD of the hand is that the joints of each individual finger may suffer from different degrees of stiffness. For example, in grasping, the 4th and 5th digits may reach the palm of the hand but the 2nd and 3rd digits may not. The flexible materials utilized in the inventive gloves 52, 54 have a much lower intrinsic strength (inherent elasticity, e.g. of about 30% to about 50%) as compared with the muscles and bones of the hand, allowing for the variations in the stiffness of each individual finger during the full range of motion, avoiding unyielding pressure over a particular joint that could lead to damage, while maintaining enough pressure to allow for the rehabilitation exercises. Furthermore, during the opening and closing of both normal and RSD affected hands, the fingers display a lateral motion which is seen as maximum separation of the fingers when the hand is fully open and maximum juxtaposition of the fingers when the hand is closed and the fingers touch the palm of the hand. The inventive glove of this apparatus is fabricated from flexible neoprene material (about 0.3 mm to about 0.7 mm, with the preferred about 0.5 mm) that is sturdy yet elastic enough to allow for the necessary lateral motion of the fingers during flexion and extension. This thin fabric utilized in the construction of the glove promotes minimal interference with the juxtaposition of the fingers when the hand is closed.

For hand exercise, to specifically target the fingers, the hand glove strap 12 fixes the hand glove 52 in place on the post 6 behind the knuckles so that only the fingers and joints from the knuckles to the tip move with the swinging handle 48 which is rotated by the motor 10, articulating the hand by being attached to the glove 52 beyond the extent of the fingers via. Hand glove 52 is essentially a tubular sleeve of the neoprene material with individual finger sleeves 52s formed therein by fastening opposite sides of the sleeve by such as stitching 52t to form sleeves individual to each finger. The open end into which the hand is inserted is closed with a strap 58 (of such as hook-and-loop material) to secure glove 52 to the post 6. The articulating end of the glove 52 is adapted with such as an orthogonal tube 52t which preferably closes the end of the glove 52 and the tube 52t is slid over handle 48 to form the articulating unit. The handle articulates in a circular arc (through range R), perpendicular to the parallel axes of the handle 48 and post 6. Incorporated into the design of the hand glove are separate finger sleeves 52s for each finger that keep the fingers snugly held while leading them into the full extension and full flexion positions. These slots, while separating the fingers, are open ended toward tube 52t, allowing the glove to adjust along the length of each finger and adapt to varying degrees of stiffness and swelling. Ventilation holes 52v along the sides of the finger sleeves 52s and the palm area help cool the hand. A glove fastening strap 12, as of such as hook-and-loop material attaches the glove 52 in place on the shaft 6 and prevents the glove from sliding off of the hand.

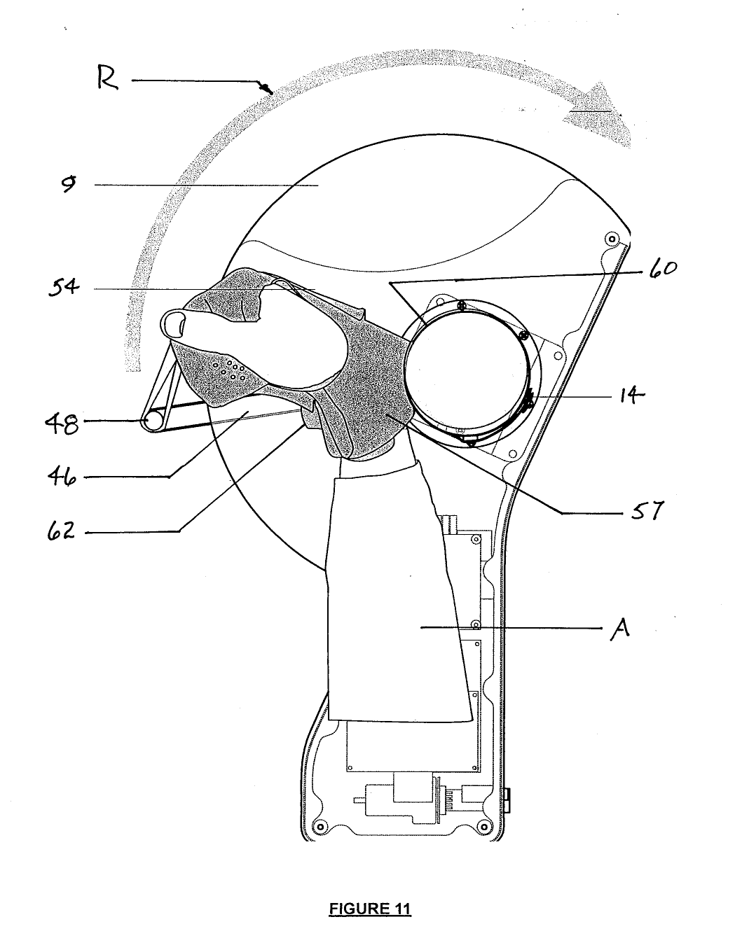

As illustrated in FIGS. 10, 11 and 12, the wrist glove 54 is attached to post 6 in a manner somewhat similar to the hand glove 52. Positioning of the wrist glove 54 varies from the hand glove 54 as the wrist connecting strap 60 holds the back of the hand/lower forearm adjacent to the post 6 at the wrist joint. As thus positioned, the articulation of the arm 46 through arc range R causes the wrist joint to go through a full pronation/supination exercise. As with the hand glove 52, the wrist connecting strap 60 is attached to the post 6 with a closure device such as snap 14. Likewise, during articulation the wrist moves through its normal range without being braced or supported by a rigid structure which would likely create a pressure point. It should be appreciated that while the fingers may ultimately demonstrate a full flexion of about 180 degrees, the wrist will exhibit only about 90 degrees of flexion. In the case of wrist exercise, the wrist glove 54 fixes the hand in place on the post 6 behind the wrist so that the wrist joint acts as the rotational axis of the exercise. To encourage the hand to act as a single unit (thereby concentrating the articulation in the wrist joint), the fingers are secured in a first position through the mechanics of a single pocket 54p that is strapped down to the palm of the glove with wrist securing strap 57. Ventilation holes 54v along the inside of the glove help to cool the hand. The hook-and-loop wrist securing strap 57 around the wrist keeps the glove in place and prevents the glove from sliding off of the hand. To enable a rapid “emergency” release, a highlighted (yellow) emergency release pull tab 56 is attached to the wrist securing strap 57 for immediate release from the glove and apparatus.

Of particular advantage in the present invention, RSD device 2 is operated through a computer software, preferably run on a portable computer, such as a laptop. Flexibility of use is gained by the use of a distinct computer since the operating software may be loaded to a computer at the exercise site, avoiding the need to carry the computer with the device 2. The software program provides a number of adjustable settings to establish various exercise regimens, selectable by the user, whether a medical professional or the patient. Preferred parameters include variable exercise ranges of motion R, variable speed of articulation and accommodation for the physical input of the patient during the exercise regimen. As indicated previously, the device 2 includes means as the torque sensor 42 and related strain gage amp 20 which measure the active input of the patient and feed the information to the computer control. The software's graphic interface displays the patient's efforts or applied pressure measured by the torque sensor in a graph that can be used to record progress over time. With such information, the medical professional may maintain or vary the regimen according to the patient input, as by adjusting the speed or drive power of the motor, or adjusting the preset range of motion R. Along with the operational function of the regimens, the control program stores not only the graphs of the patient's effort, but also the settings for the regimen, such as time, range of operation, incidence and duration of patient input.

In general operation, it is preferable that the RSD device 2 be connected to the control (computer) prior to applying drive power (ac power) to the RSD device 2. One then opens the control function, accessing whatever data, regimes and functions as are anticipated to be used. Then the operational parameters of the particular regimen to be used are set, as the articulating range and speed of the exercise handle 46. Then such as the number of cycles are to form the exercise, what data is to be stored Also, where the exercise is to be interactive, the levels of patient activity and the response of the device are set. Once the exercise information is input, the RSD device 2 is ready for the patient. The particular glove 52/54 for the intended exercise is selected and placed on the patient, and then the glove is attached to the post 6. When the patient is ready, the exercise may be initiated. Controls are included for pausing the device or for an “Emergency Stop”.

In the preferred embodiment, the arm 46 is capable of articulating through an angular range of about 200 degrees. A standard mid-range (neutral) position (e.g., FIG. 7, FIG. 10) is the starting point and the articulation of hand or wrist will be set by the healthcare practitioner to a beginning range of motion within the patient's capability. When the device is being run, there are two cases that the device takes into consideration. The first is when the patient's hand is stiff or only slightly moveable and the device is entirely driving the extension and flexion motion of the hand. Second is when the patient is able to move his/her hand through the motions well enough that the hand “outruns” or advances past the speed of the handle (and therefore motor). In case 1, the default behavior of the system, the user interface software commands the motor (and therefore handle) to move through a repeated trajectory (default is a triangle wave of configurable slope). This is accomplished by the user interface software sending incremental positions that follow a triangle wave trajectory (FIG. 13). Based on user input to the user interface software, the slope and amplitude of the triangle wave can be modified. In the language presented to the user via the user interface software, the amplitude is equivalent to the location of the limits of motion set by the user. The slope is representative of the speed. The speed at which the motor “accelerates to get “out of the way” (see description below) is the “sensitivity”. In case 2, torques applied externally (by the user) to the motor are measured by the load cell and recorded in the motor controller. The user interface software reads the measurement via communication with motor controller (at approximately 80 times per second) and may change the slope of the aforementioned waveform. When the patient's hand is “outrunning” the handle, it is going through the motions at a strong and fast enough manner that it is moving faster than the handle. In this situation, the handle, depending on the sensitivity setting, accelerates forward to get out of the way of the hand to allow the hand to move assistance-free. The slope of the waveform is changed according to the following algorithm: if the applied torque is in the direction of motion (same sign as the velocity), the velocity is increased in magnitude in an attempt to keep the measured torque at 0 (motor 10, and therefore the handle 46, accelerates to “get out of the way” of the user)—if the applied torque is in the opposite direction, the waveform is unmodified. A usual regimen will include a plurality of series of repetitions such as three series of 25 repetitions. Depending upon the flexibility of the patient's hand or wrist, the initial series is set within the comfortable range of flexion and extension. Thereafter, successive series of repetitions will be increased in increments of approximately 5 degrees. Additionally, the speed of angular flexion is varied over a course of treatment. In the beginning of a treatment program, wherein the range of flexion of a hand might be only about 60 to 90 degrees, the speed of rotation would be at a relatively slow rate so as to not cause undue stress on the hand. Rotation in such a setting may be around 5 to 10 degrees per second with the set range of flexion taking 5 to 20 seconds. As flexibility increases, the angular speed is increased, as is the angular range. The health care professional will define an appropriate regimen for the particular patient and set the parameters in to the machine. A start/stop button is in easy reach of the patient to initiate and terminate the regimen, as desired.

The following table lists the parts numbers and parts descriptions as used herein and in the drawings attached hereto.

| Part Number | Description |
|---|---|
| A | Patient arm |
| 2 | Rehabilitative apparatus |
| 4 | Structural channel |
| 6 | Motor housing |
| 8 | Encoder/position sensor |
| 10 | Motor |
| 12 | Glove hand strap |
| 14 | Snap |
| 16 | HD Gearhead |
| 18 | Top plate |
| 20 | Strain gauge amp |
| 22 | Power supply |
| 24 | Top track |
| 26 | Power supply connector |
| 28 | Stand-off |
| 30 | D Sub terminator |
| 32 | Base plate |
| 33 | Non-slip pad |
| 34 | Bottom track |
| 36 | Motor control board |
| 38 | Angle bracket |
| 40 | Interconnect board |
| 42 | Torque sensor |
| 44 | Protective shield |
| 46 | Arm |
| 46c | Arm flexed |
| 46n | Arm neutral |
| 46o | Arm extended |
| 48 | Cylindrical handle |
| 50 | Arm rest pad |
| 52 | Hand exercise glove |
| 52s | Hand finger sleeve |
| 52t | Glove attachment tube |
| 52v | Glove ventilation holes |
| 54 | Wrist exercise glove |
| 54p | Wrist pocket |
| 54v | Wrist ventilation holes |
| 56 | Glove emergency release tab |
| 57 | Wrist securing strap |
| 58 | Hand connecting strap |
| 60 | Wrist connecting strap |
| 62 | Wrist emergency pull tab |

The foregoing embodiments are presented by way of example only; the scope of the present invention is to be limited only by the following claims.

1. A rehabilitative apparatus for treatment of reflex sympathetic dystrophy comprising
a) a frame, having mounted thereon a motor with a reciprocating shaft oriented in a vertical orientation to said frame;
b) a horizontally oriented arm attached to said motor shaft, having at its end opposite the attachment to said motor shaft a handle extending generally parallel to the shaft of said motor, whereby said handle is reciprocated through an arc of about 180 degrees on reciprocal operation of said motor;
c) a cylindrical motor housing extending from centrally of said motor upwardly a distance generally a distance similar to said handle;
d) an exercise glove for securing a limb to said cylindrical housing proximate a joint in said limb, said limb being secured to said housing extending in an orientation to allow reciprocation of the limb about said joint by the arc rotation by attachment of said glove to said handle;
e) motor control means for directing said motor in reciprocal motion through a controllable arc of about 180 degrees, at a controllable rate of about 3 to about 10 seconds for the arc of rotation.

2. The apparatus of claim 1 wherein the exercise glove is for the fingers, including a web having individual sleeves for each finger, and fastening means for connecting the finger end web section of the glove to the handle, and fastening means for fastening the back side of the glove adjacent the body of the hand, to the cylindrical motor housing, whereby rotation of the handle through the exercise arc. provides individual articulation of the fingers through the extent of the arc.

3. The apparatus of claim 1 wherein the exercise glove is for the wrist, including hand holding sleeve attachable to the cylindrical housing at the back of the wrist joint, whereby the joint acts as the rotational axis for the hand, and an extending socket for the fingers to be contained together, and is bendable to secure the folded fingers generally to the glove opposite the wrist joint, and a loop extending from the pocket of the glove generally immediate the middle section of the fingers, said loop being connectable to the handle to effect rotation of the wrist as the hand is articulated through the arc of operation.
